(19) United States
(12) Patent Application Publication
(10) Pub. No.: US 2001/0052728 A1
(43) Pub. Date: Dec. 20, 2001

(54) Motor vehicle door locking system arrangement

(76) Inventors: Goran Larsson, Torslanda (SE); Anders Gunnarsson, Goteborg (SE); Simon Lamarre, Vastra Frolunda (SE); Karin Reikeras, Dampierre-en-Y (FR); Kjell Reikeras, Hokerum (SE); Einar Lenartsson, Sollebrunn (SE); Birgitta Thorsson, Varberg (SE); Ake Bergqvist, Vastra Frolunda (SE)

Correspondence Address: TRACY W. DRUCE, KILPATRICK STOCKTON LLP, 11130 SUNRISE VALLEY DRIVE, SUITE 300, RESTON, VA, 20191-4329, US

(21) Appl. No.: 09/681,890

(22) Filed: Jun. 21, 2001

Related U.S. Application Data
(63) Continuation of application No. PCT/SE99/02337, filed on Dec. 14, 1999.

(30) Foreign Application Priority Data
Dec. 21, 1998 (SE) 9804470-4

(51) Int. Cl. H02G 3/00

(52) U.S. Cl. 307/9.1

(57) ABSTRACT

An arrangement in a door locking system, intended for a motor vehicle, is disclosed. The system is designed to receive from an authorization verification element an unlocking signal emitted by the element in order to automatically unlock at least one vehicle door lock, preferably on the driver's side, when the signal is emitted closer than a predetermined distance from the lock. The lock has a manually activatable sensor electrically connected to the lock mechanism. The lock is designed such that the sensor, when activated, causes the lock mechanism to release the door. The lock mechanism is designed to open the door automatically a predetermined angle.

### CROSS REFERENCE TO RELATED APPLICATIONS

This is a continuation patent application of International Application No. PCT/SE99/02337 filed Dec. 14 1999 that designates the United States. The full disclosure of said application, in its entirety, is hereby expressly incorporated by reference into the present application.

### BACKGROUND OF INVENTION

Technical Field. The present invention relates to a door locking system arrangement for use in a motor vehicle. More specifically, the present invention relates to a door locking system arrangement wherein an unlocking signal is emitted from an authorization verification element. This signal activates a sensor connected to a door lock mechanism that releases the door. Prior to emitting the unlocking signal, the door lock mechanism is powerless.

Background Information. Door locking systems for motor vehicles that may be unlocked by an authorization verification element have come to be used mainly in motor vehicles in the upper price ranges. These systems make vehicle access more convenient for the person who is getting into and using the vehicle.

### SUMMARY OF INVENTION

One object of the present invention is to improve vehicle security against unwarranted unlocking of the doors and luggage compartment of the motor vehicle.

Another object of the present invention is to minimize the force required in order to open a vehicle door. Yet another object of the present invention is to allow a handicapped person or a person with impaired manual strength to open the vehicle door.

These objects are achieved by a door locking system arrangement wherein an authorization verification element emits a signal for unlocking at least one door of a motor vehicle. The door locking system has a manually activatable sensor electrically connected to the lock mechanism that is designed, when activated, to cause the lock mechanism to release the door. The lock mechanism is further designed to open the door a predetermined opening angle or amount.

In its locked state or condition, the door locking system is entirely without power. Due to the fact that the door locking system is entirely without power in its locked condition, it is difficult for an unauthorized person to tamper with.

Since the door opens automatically a short way, it can be opened fully with very little effort for getting in and out of the vehicle. The special construction of the locking system also makes it very secure against the risk of anyone opening the vehicle doors from the outside in an attempted attack or theft.

### BRIEF DESCRIPTION OF DRAWINGS

Further advantages of the invention will be apparent from the dependent claims and from the following description with reference to the drawings, in which:

FIG. 1 shows a perspective view of a door handle according to the present invention;

FIG. 2 shows a cross-sectional view of a sensor arrangement in FIG. 1; and

FIG. 3 shows a schematic block diagram of an example of a locking system according to the present invention.

### DETAILED DESCRIPTION

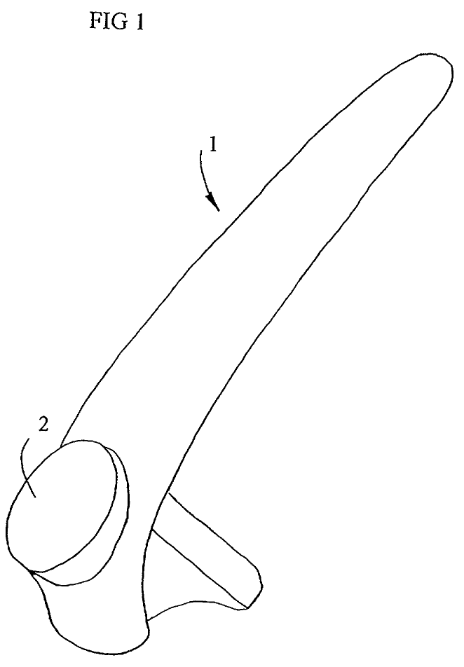

In FIG. 1, the reference number 1 denotes a handle intended to be fitted on the outside of a motor vehicle door. In one embodiment, the vehicle is an electric or hybrid vehicle. The handle 1 is designed so that it can be easily grasped in order to open and close the door so that a person is able to get into and out of the vehicle unimpeded. The handle 1 is provided with an activatable element 2 that is designed to be touch-activated, as will be described in more detail below.

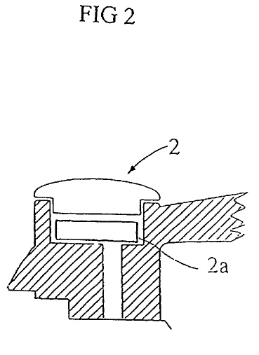

The cross-sectional view in FIG. 2 shows the above-mentioned activating element 2. The activating element 2 takes the form of a manually activatable sensor that is electrically connected to the vehicle's locking mechanism. The element or sensor 2 has a sensing element 2a in the form, for example, of a micro-circuit breaker. The sensor 2 is designed to cause the locking mechanism to release the door when activated. Thereafter, the door is designed to open automatically a predetermined opening angle. In one embodiment the sensor is a limit switch. In another embodiment the sensor is a touch-sensitive sensor.

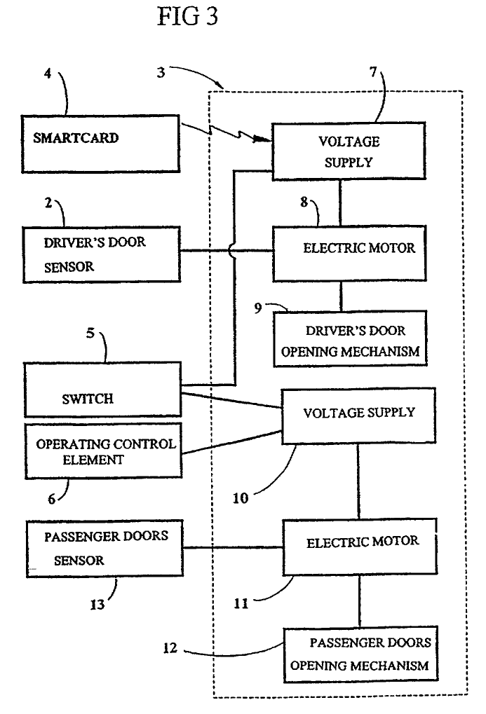

In FIG. 3, the door locking system is denoted by reference number 3. Various elements for activating the locking system 3 include an authorization verification element in the form of, for example, a so-called smartcard 4, sensors 2, 13, a switch 5 and one or more operating control elements 6. In one embodiment, the door locking system 3 is designed to receive from the smartcard 4 an unlocking signal. The signal is emitted by means of the smartcard 4 for bringing about automatic unlocking when it is emitted closer than a predetermined distance from the lock. In an alternative embodiment, the smartcard includes a so-called transponder designed to receive a signal emitted from the door locking system. The transponder then returns an authorization code that allows a control unit to switch on the power supply to the door lock. The locking function is accomplished by the door locking system, which is without power in the locked position, and is provided with power upon receiving the unlocking signal. In the example illustrated in FIG. 3, there is a separate partial locking system intended for the driver's door. The system is provided in this phase with a voltage supply by means of the smartcard 4 and a voltage supply source 7. When the locking system of the driver's door is supplied with a voltage, the sensor 2 is activated automatically. Once activated, an opening mechanism 9 for the driver's door causes the door to release as described above and to open automatically by a predetermined opening angle. The locking mechanism itself or the door weather seal pushes the door outwards. In FIG. 3, the opening mechanism 9 is controlled by an electric motor 8. A number of other embodiments are naturally conceivable. For example, the opening mechanism might be controlled by an arrangement with magnetic action rather than by an electric motor. There are many ways of producing the opening mechanism known to one skilled in the art.

The operating control element or elements 6 for electrically unlocking the locks of the other doors of the vehicle are arranged adjacent to the vehicle driver's seat. In the example with only one operating control element 6, this is designed, when activated, to connect a voltage supply source 10 to the part of the door locking system 3 intended for the passenger doors. In the example with more than one operating control element 6, the number of such elements may correspond to the number of passenger doors, as well as a rear door or luggage compartment. Each of the operating control elements 6 is then designed, when activated, to electrically connect the voltage supply source 1 0 to the part of the door locking system 3 relating to the passenger door corresponding to the operating control element.

With a voltage supply to the part of the door locking system relating to the passenger doors, electric motors 11 can be activated by means of the sensors 2 in the same way as for the driver's door. There may be at least one sensor for each door and/or compartment, fitted on the outside of the door(s) and/or compartment(s) for actuating opening mechanisms 12 for opening the door(s) and/or compartment(s).

The vehicle doors are closed manually. According to one embodiment, the locks for all doors are designed to assume the locked position once the vehicle has attained a predetermined speed, for example, about 5 km/h. This is achieved by means of a mechanism that electrically disconnects the voltage supply sources 7, 10 from the remainder of the locking system 3. The switch 5 may be arranged adjacent to the driver's seat and connected to the above-mentioned mechanism for disconnecting the voltage supply sources from the remainder of the locking system 3. All vehicle doors can thereby be locked whenever required. In another embodiment there is a switch 5 for each door so that they can be locked individually. In another embodiment the operating control element(s) 6 and the switch(es) 5 physically constitute one and the same element, with one single activation serving to bring about unlocking and a second activation serving to bring about locking.

Sensors corresponding to the sensors 2 described above can be arranged at suitable points on the inside of the vehicle doors in order to permit opening from inside the vehicle. It is also possible to restrict this opening facility by means of the switch(es) 5. This may be desirable, for example, if there is a child in any of the passenger seats.

The smartcard 4 may have a number of other functions. For example, it may be provided with means to permit remotely controlled unlocking of the passenger doors from outside; such unlocking might be achieved by activating of an activating element arranged in the smartcard. In addition, the smartcard might be used as an engine immobilizer key and be designed for docking in a docking part in the vehicle's steering wheel hub in order to allow the vehicle to be driven.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

1. An electrical door locking system arrangement for a motor vehicle designed to receive an unlocking signal emitted by an authorization verification element for automatically unlocking one or more vehicle door locks when said signal is emitted closer than a predetermined distance from said lock, said locking system comprising:
a manually activatable sensor electrically connected to said lock mechanism, wherein said sensor is designed when activated to cause said lock mechanism to release the door,
and further wherein said lock mechanism is designed to automatically open one or more doors by a predetermined opening angle,
wherein said door locking system in a locked condition is entirely without power until an unlocking signal emitted closer than a predetermined distance switches on a power supply to said door lock.

2. The arrangement according to claim 1 wherein an operating control element adjacent to the vehicle driver's seat is designed when activated to electrically connect a voltage supply source to parts of said door locking system belonging to at least one of the passenger doors, rear door or luggage compartment.

3. The arrangement according to claim 1 wherein said door is designed to open automatically by said predetermined opening angle under action of a door weather seal.

4. The arrangement according to claim 1 wherein said sensor is accessible from outside.

5. The arrangement according to claim 1 wherein said sensor is located adjacent to a door handle.

6. The arrangement according to claim 1 wherein said vehicle door lock on the driver's side is sensitive to said unlocking signal and wherein there is an operating control element for said power supply to said locks of the other vehicle door inside said vehicle adjacent to the driver's seat.

7. The arrangement according to claim 1 wherein said sensor is a limit switch.

8. The arrangement according to claim 1 wherein said sensor is a touch-sensitive sensor.

9. The arrangement according to claim 1 wherein said lock is designed to assume the locked position through operation of a switch adjacent to the driver's seat.

10. The arrangement according to claim 1 wherein said lock is designed to assume the locked position when said vehicle attains a predetermined speed.

11. The arrangement according to claim 1 wherein said authorization verification element is a smartcard, and
further wherein there is a docking part for said smartcard in the steering wheel hub.
